(19) United States
(12) Patent Application Publication
(10) Pub. No.: US 2012/0324122 A1
(43) Pub. Date: Dec. 20, 2012

(54) METHOD AND APPARATUS FOR SERVER-SIDE ADAPTIVE STREAMING

(76) Inventors: David Miles, Mountain View, CA (US); Venugopal Hemige, San Ramon, CA (US)

(21) Appl. No.: 13/163,838

(22) Filed: Jun. 20, 2011

(51) Int. Cl. G06F 15/16

(52) U.S. Cl. 709/231

(57) ABSTRACT

A server-side adaptive streaming capability is provided. The server-side adaptive streaming capability supports adaptive streaming of a data object from a server toward a client via a Transmission Control Protocol (TCP) connection between the server and the client. The server has access to a plurality of versions of the data object having a respective plurality of encoding bit rates associated therewith. The server has a TCP congestion control mechanism running for the TCP connection. The TCP congestion control mechanism has information associated therewith. The server determines, using the information associated with the TCP congestion control mechanism running on the server for the TCP connection, a transmission bit rate expected to be supported by the client for the TCP connection. The server selects, based on the transmission bit rate expected to be supported by the client and the encoding bit rates associated with the versions of the data object accessible to the server, one of the plurality of versions of the data object for propagation from the server toward the client via the TCP connection. The server dynamically switches between the versions of the data object as the transmission bit rate expected to be supported by the client changes.

### TECHNICAL FIELD

The invention relates generally to communication networks and, more specifically but not exclusively, to streaming content via communication networks.

### BACKGROUND

In general, streaming of video content from a server to a client typically utilizes video encoding methods (e.g., one or more of the Moving Picture Experts Group (MPEG) standards, H.264/Advanced Video Coding (AVC), and the like) which allow for real-time delivery and presentation of content (e.g., video content and, optionally, audio content). The video encoding methods attempt to deliver a target frame-rate and a target video bit rate (or video quality) for video content to be streamed. The video content, once encoded, needs to be delivered at least as fast as the encoded bit rate or the presentation of frames of the video content to the end user may be negatively impacted.

### SUMMARY

Various deficiencies in the prior art are addressed by embodiments for providing server-side adaptive streaming.

In one embodiment, an apparatus for adaptive streaming of a data object from a server toward a client via a Transmission Control Protocol (TCP) connection, where the server has access to a plurality of versions of the data object having a respective plurality of encoding bit rates associated therewith, is provided. The apparatus includes a processor and a memory. The processor is configured to determine, from information associated with a TCP congestion control mechanism running on the server for the TCP connection, a transmission bit rate expected to be supported by the client for the TCP connection. The processor also is configured to select, based on the transmission bit rate expected to be supported by the client and the encoding bit rates associated with the versions of the data object accessible to the server, one of the plurality of versions of the data object for propagation from the server toward the client via the TCP connection.

In one embodiment, a method for adaptive streaming of a data object from a server toward a client via a Transmission Control Protocol (TCP) connection, where the server has access to a plurality of versions of the data object having a respective plurality of encoding bit rates associated therewith, is provided. The method includes determining, from information associated with a TCP congestion control mechanism running on the server for the TCP connection, a transmission bit rate expected to be supported by the client for the TCP connection, and selecting, based on the transmission bit rate expected to be supported by the client and the encoding bit rates associated with the versions of the data object accessible to the server, one of the plurality of versions of the data object for propagation from the server toward the client via the TCP connection.

In one embodiment, a computer-readable storage medium is provided, where the computer-readable storage medium stores instructions which, when executed by a computer, cause the computer to perform a method for adaptive streaming of a data object from a server toward a client via a Transmission Control Protocol (TCP) connection, where the server has access to a plurality of versions of the data object having a respective plurality of encoding bit rates associated therewith. The method includes determining, from information associated with a TCP congestion control mechanism running on the server for the TCP connection, a transmission bit rate expected to be supported by the client for the TCP connection, and selecting, based on the transmission bit rate expected to be supported by the client and the encoding bit rates associated with the versions of the data object accessible to the server, one of the plurality of versions of the data object for propagation from the server toward the client via the TCP connection.

### BRIEF DESCRIPTION OF THE DRAWINGS

The teachings herein can be readily understood by considering the following detailed description in conjunction with the accompanying drawings, in which:

FIG. 1 depicts an exemplary communication system illustrating use of a server-side adaptive streaming mechanism to stream data from a server to a client;

FIG. 2 depicts an exemplary embodiment of the server-side adaptive streaming mechanism of the server of FIG. 1;

FIG. 3 depicts one embodiment of a method by which a server selects, from among multiple versions of a data object available to the server, one of the versions of the data object from which to propagate a portion of the data object toward a client via a TCP connection;

FIG. 4 depicts use of a server-side adaptive streaming mechanism on a server to produce an output data stream for a client from three encoded versions of the data object accessible to the server; and

FIG. 5 depicts a high-level block diagram of a computer suitable for use in performing the functions described herein.

To facilitate understanding, identical reference numerals have been used, where possible, to designate identical elements that are common to the figures.

### DETAILED DESCRIPTION OF ILLUSTRATIVE EMBODIMENTS

In general, a server-side adaptive streaming capability is depicted and described herein, although various other capabilities also may be presented herein. In at least some embodiments, the server-side adaptive streaming capability enables a server to adaptively stream a data object to a client via a Transmission Control Protocol (TCP) connection by outputting a contiguous data stream formed by selecting from among multiple versions of the data object based on information available from a TCP congestion control mechanism operating on the server for the TCP connection. The information available from the TCP congestion control mechanism is analyzed by the server to determine a transmission bit rate expected to be supported by the client based on analysis of the information available from the TCP congestion control mechanism. The multiple versions of the data object have respective encoding bit rates associated therewith. The server is configured to select from among the versions of the data object based on the transmission bit rate expected to be supported by the client as determined by the server and the encoding bit rates of the versions of the data object available to the server. In one embodiment, the server is configured to select the version of the data object having a largest encoding bit rate which can be supported by the transmission bit rate expected to be supported by the client as determined by the server based on analysis of the information available from the TCP congestion control mechanism. The server may be configured to perform such functions periodically, in response to events, and the like, as well as various combinations thereof. The server is configured to dynamically switch between the versions of the data object as the transmission bit rate expected to be supported by the client changes. As the server selects from among the versions of the data object, the server outputs a contiguous data stream formed by selecting from among the multiple versions of the data object, thereby enabling the client to receive the highest quality data stream, that the client is capable of receiving, at any given point in time. Various other functions and capabilities of embodiments of the server-side adaptive streaming capability may be better understood by way of reference to the following description and the associated drawings.

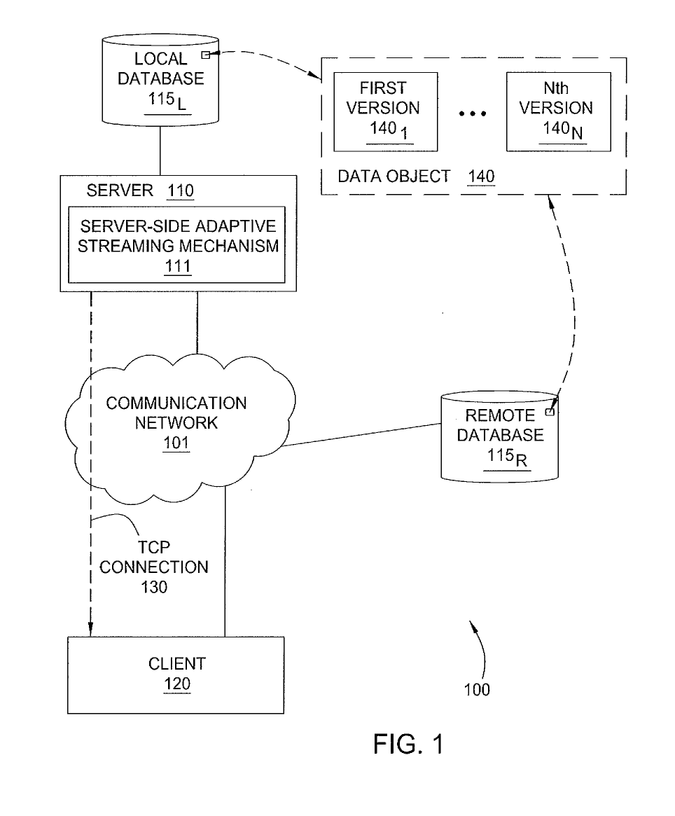

FIG. 1 depicts an exemplary communication system illustrating use of a server-side adaptive streaming mechanism to stream data from a server to a client.

The exemplary communication system 100 includes a communication network 101, a server 110, and a client 120. A TCP connection 130 is established between the server 110 and client 120, via communication network 101, for enabling the server 110 to stream data to the client 120.

The communication network 101 may include any communication network configured for supporting TCP-based communications.

The server 110 is configured for streaming data to clients using TCP connections (illustratively, to client 120 via TCP connection 130).

The server 110 has access to data available to be streamed from server 110 to client 120.

The data which is streamed from the server 110 to the client 120 via the TCP connection 130 may be accessed locally (e.g., in a local database 115_{L} of server 110) and/or remotely (e.g., from a remote database 115_{R} that is remote from server 110).

The data which is streamed from the server 110 to the client 120 via the TCP connection 130 may include any type(s) of data suitable for being streamed using TCP. For example, the data may include audio, video, multimedia, text, software, and the like, as well as various combinations thereof.

The data which is streamed from the server 110 to the client 120 via the TCP connection 130 may be maintained, accessed, and controlled in the form of data objects. For example, a data object may be a song, a music album, a television show, a portion of a television show, a movie, a portion of a movie, a data stream requiring real-time delivery, and the like.

The server 110 has access to multiple versions of a data object to be streamed to client 110. The multiple versions of the data object correspond to different encoding bit rates and, thus, have different levels of quality associated therewith. The multiple versions of the data object may be maintained as separate files including the same data encoded at different bit rates. For example, for a given data object, low, medium, and high quality versions of the data object (e.g., corresponding to encoding at associated low, medium and high bit rates, respectively) may be supported. For example, for this given data object, encoding bit rates of the low, medium, and high quality versions of the data object may be 1 Mbps, 2 Mbps, and 4 Mbps, respectively. It is noted that these data object versions are merely exemplary, and that fewer for more data object versions may be supported for a data object (i.e., two or more versions of a data object may be used for providing the server-side adaptive streaming capability). Similarly, it is noted that these encoding bit rates are merely exemplary, and that any suitable encoding bit rates may be used for providing different versions of a data object. The multiple versions of a data object may be stored in one storage location (e.g., either in local database 115_{L} or in remote database 115_{R}) or distributed across multiple storage locations (e.g., using local database 115_{L} and remote database 115_{R} and/or any other suitable data storage locations).

An exemplary data object 140, maintained and available as multiple data object versions 140₁-140_{N}, is depicted in FIG. 1. For the exemplary data object 140, it is noted that data object version 140₁ may correspond to the lowest quality version of the data object and data object version 140_{N} may correspond to the highest quality version of the data object. As noted above, two or more versions of a data object may be used for providing the server-side adaptive streaming capability.

The client 120 is configured to receive streaming data via a TCP connection (illustratively, via TCP connection 130 from server 110). The client 120 also may be configured for providing one or more additional functions related to the streaming data (e.g., presenting the streaming data at the client 120, processing the received data at client 120, propagating the received data toward one or more other devices (e.g., for presentation, processing, and/or other related functions) and the like, as well as various combinations thereof). For example, the client 120 may be a desktop computer, a laptop computer, a tablet, a smartphone, a set top box (STB), a television, or any other device which may receive streaming data via a TCP connection.

In one embodiment, the server 110 is configured to support a server-side adaptive streaming capability. As depicted in FIG. 1, this capability is represented as server-side adaptive streaming mechanism 111, which may be implemented on server 110 in any suitable manner. The server-side adaptive streaming mechanism 111 may provide various functions of the server-side adaptive streaming capability depicted and described herein.

The server 110 is configured to propagate the data object toward client 120 in portions (or segments) and, for each portion of the data object to be propagated from the server 110 toward client 120, the server 110 may select that portion of the data object from among the multiple versions of the data object available to the server 110. As server 110 selects portions of the data object from among the multiple versions of the data object available to the server 110, the server 110 propagates the selected portions of the data object toward client 120 via TCP connection 130. In this manner, the server 110 is able to output a single contiguous data stream for propagation toward client 120, even though the server 110 may have assembled the data stream from multiple different versions of the data object.

The server 110 is configured to perform a process in order to select, for a given portion of the data object to be provided to client 120, which version of the data object is used to provide that given portion of the data object.

In one embodiment, the server 110 determines a transmission bit rate expected to be supported by the client 120, and selects which version of the data object is used to provide that given portion of the data object based on the determined transmission bit rate expected to be supported by the client 120 and the encoding bit rates of the versions of the data object available for selection by server 110.

In one embodiment, the server 110 determines a transmission bit rate expected to be supported by the client 120 using information, associated with the TCP connection 130, that is available on server 110.

In one embodiment, the server 110 determines a transmission bit rate expected to be supported by the client 120 using information associated with the TCP congestion control mechanism running on the server 110 for the TCP connection 130.

In general, TCP congestion control is a component of TCP. For example, TCP congestion control has been defined in various Internet Engineering Task Force (IETF) Requests for Comment (RFCs), such as RFC 793, RFC 2001 (TCP Slow Start, Congestion Avoidance, Fast Retransmit, and Fast Recovery Algorithms), RFC 2581 (TCP Congestion Control), and the like. As a result, a TCP congestion control mechanism may be implemented using various features of one or more such RFCs.

In general, a TCP congestion control mechanism for a TCP connection is configured to adapt the current transmission bit rate for the TCP connection based on monitoring of information associated with the TCP connection. For example, a TCP congestion control mechanism may be configured to perform monitoring of the TCP connection (e.g., monitoring one or more parameters and/or monitoring for one or more events in order to detect congestion associated with the TCP connection), and to set the transmission bit rate for the TCP connection based on such monitoring of the TCP connection. In this manner, the TCP congestion control mechanism is able to control and adapt the current transmission bit rate for the TCP connection based on the current state of the TCP connection (e.g., by controlling the speed with which data is removed from a queue for transmission from the server toward a client via the TCP connection).

In one embodiment, information associated with the TCP congestion control mechanism running on the server 110 for the TCP connection 130 includes an effective transmission bit rate currently supported by the TCP congestion control mechanism running on the server 110 for the TCP connection 130. In one such embodiment, the effective transmission bit rate currently supported by the TCP congestion control mechanism running on the server 110 may be used by the server 110 as the transmission bit rate expected to be supported by the client 120.

In one embodiment, the information associated with the TCP congestion control mechanism running on the server 110 for the TCP connection 130 also may include additional information (e.g., one or more parameters and/or one or more events) associated with the TCP connection 130 that is available on server 110. For example, additional information associated with the TCP connection 130 which may be determined from the TCP congestion control mechanism running on the server 110 for the TCP connection 130 may include packet loss information, round trip delay information, and the like, as well as various combinations thereof. In one such embodiment, at least a portion of the additional information associated with the TCP connection 130 may be used, in combination with the effective transmission bit rate currently supported by the TCP congestion control mechanism running on the server 110, to determine the transmission bit rate expected to be supported by the client 120. For example, the effective transmission bit rate currently supported by the TCP congestion control mechanism running on the server 110 may be modified based on the additional information to compute the transmission bit rate expected to be supported by the client 120. The use of such additional information may result in determination of a more accurate transmission bit rate expected to be supported by the client, and may even result in determination of an optimal transmission bit rate expected to be supported by the client.

In one embodiment, although primarily depicted and described with respect to embodiments in which the server 110 selects from among the multiple versions of the data object based only on information available at the server 110, the server 110 also may be configured to select from among the multiple versions of the data object using a combination of (1) the information associated with the TCP connection 130 that is available on the server 110 and (2) information associated with the TCP connection 130 that is provided to the server 110 by the client 120. In one such embodiment, for example, the server 110 determines a transmission bit rate expected to be supported by the client 120 using a combination of (1) the information associated with the TCP connection 130 that is available on the server 110 and (2) information associated with the TCP connection 130 that is provided to the server 110 by the client 120. The information associated with the TCP connection, provided to the server 110 by the client 120, may be provided in any suitable manner (e.g., using an adaptive streaming feedback capability of the client 120 and/or in any other suitable manner).

It is noted that the TCP congestion control mechanism running on the server 110 for TCP connection 130 may be implemented on the server 110 in a number of ways and, thus, that the information associated with the TCP congestion control mechanism running on the server 110 for TCP connection 130 may be determined. In one embodiment, for example, in which the TCP congestion control mechanism running on server 110 is implemented as part of a TCP stack of the server 110, the information associated with the TCP congestion control mechanism running on the server 110 for the TCP connection 130 may be determined from the TCP stack of the server 110. In one embodiment, for example, in which the TCP congestion control mechanism running on the server 110 is implemented such that at least a portion of the TCP congestion control mechanism is not implemented as part of the TCP stack of the server 110, the information associated with the TCP congestion control mechanism running on the server 110 for the TCP connection 130 may be determined from the TCP congestion control mechanism as it is implemented on the server 110. From the foregoing embodiments, it will be appreciated that the information associated with the TCP congestion control mechanism running on the server 110 for the TCP connection 130 may be determined in any suitable manner.

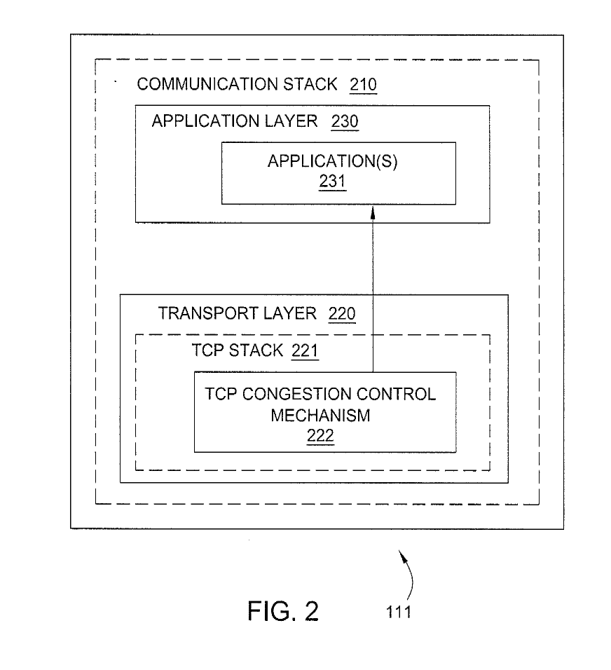

In one embodiment, the determination of the transmission bit rate expected to be supported by the client 120 is performed by an application running at an application layer of a communications stack implemented on the server 110. In one embodiment, for example, the information associated with the TCP congestion control mechanism running on the server 110 (e.g., specifying the transmission bit rate expected to be supported by the client 120 and/or for use in determining the transmission bit rate expected to be supported by the client 120) may be received at the application layer of the communications stack from a transport layer of the communications stack (e.g., where the information is received from a TCP stack implemented on the server 110). In one embodiment, for example, the information associated with the TCP congestion control mechanism running on the server 110 (e.g., specifying the transmission bit rate expected to be supported by the client 120 and/or for use in determining the transmission bit rate expected to be supported by the client 120) may be received at the application layer of the communications stack from a process running at the application layer of the communications stack (e.g., such as where a version of the TCP stack of the transport layer of the communications stack is implemented at the application layer of the communications stack for enabling the application to obtain the information associated with the TCP congestion control mechanism running on the server 110). The information associated with the TCP congestion control mechanism running on the server 110 may be made available to the application in any other suitable manner. An exemplary embodiment is depicted and described with respect to FIG. 2.

FIG. 2 depicts an exemplary embodiment of the server-side adaptive streaming mechanism of the server of FIG. 1.

As depicted in FIG. 2, server-side adaptive streaming mechanism 111 of the server 110 is implemented in conjunction with a communication stack 210 of server 110.

The communication stack 210 includes a transport layer 220 and an application layer 230_{A} (among other layers which are omitted for purposes of clarity).

The transport layer 220 includes a TCP stack 221 supporting a TCP congestion control mechanism 222. It is noted that, as described hereinabove, the TCP congestion control mechanism 222 may be provided independent of the TCP stack 221.

The application layer 230 supports an application 231 configured to perform various functions of the server-side adaptive streaming capability. For example, application 231 may be configured to receive information from TCP congestion control mechanism 222 for use in determining transmission bit rate expected to be supported by client 120, determine the transmission bit rate expected to be supported by client 120 based on information received from TCP congestion control mechanism 222, select portions of a data object from among multiple versions of the data object based on the transmission bit rate expected to be supported by the client 120 (and, optionally, other information), and the like, as well as various combinations thereof.

It is noted that FIG. 2 merely represents one exemplary implementation of the server-side adaptive streaming mechanism 111, and that various other implementations may be provided.

As described hereinabove, and returning now to FIG. 1, server 110 is configured to select, based on the determined transmission bit rate expected to be supported by the client 120 and the encoding bit rates of the versions of the data object available for selection by server 110, which version of the data object is used to provide that given portion of the data object to the client 120.

In one embodiment, the server 110 is configured to select the version of the data object having an associated encoding bit rate best suited for the determined transmission bit rate expected to be supported by the client 120.

In one embodiment, for example, the encoding bit rate best suited for the determined transmission bit rate is the largest encoding bit rate that is less than or equal to the transmission bit rate. For example, where the data object to be provided to the client 120 is available in low, medium, and high quality versions having associated encoding bit rates of 1 Mbps, 2 Mbps, and 4 Mbps, respectively, and the transmission bit rate expected to be supported by the client 120 is 3.8 Mbps, the server 110 selects the medium quality version of the data object as the source of that portion of the data object to be provided to client 120 (since the 3.8 Mbps transmission bit rate is large enough to support the 2 Mbps encoding bit rate of the medium quality version of the data object, but not quite large enough to support the 4 Mbps encoding bit rate of the high quality version of the data object).

In one embodiment, for example, the encoding bit rate best suited for the determined transmission bit rate is the largest encoding bit rate that is less than the transmission bit rate as long as the transmission bit rate is at least a threshold amount larger than that largest encoding bit rate; otherwise, the next lowest encoding bit rate is selected. For example, where the data object to be provided to the client 120 is available in low, medium, and high quality versions having associated encoding bit rates of 1 Mbps, 2 Mbps, and 4 Mbps, respectively, and the transmission bit rate expected to be supported by the client 120 is 2 Mbps, the server 110 selects the low quality version of the data object as the source of that portion of the data object to be provided to client 120 (although the 2 Mbps transmission rate is just large enough to support the 2 Mbps encoding bit rate of the medium quality version of the data object, any slight decrease in the transmission bit rate supported by the client 120 may result in problems with transmission of the data object to the client 120 such that it may be prudent to, at least initially, select that low quality version of the data object that can definitely be supported by the determined transmission bit rate).

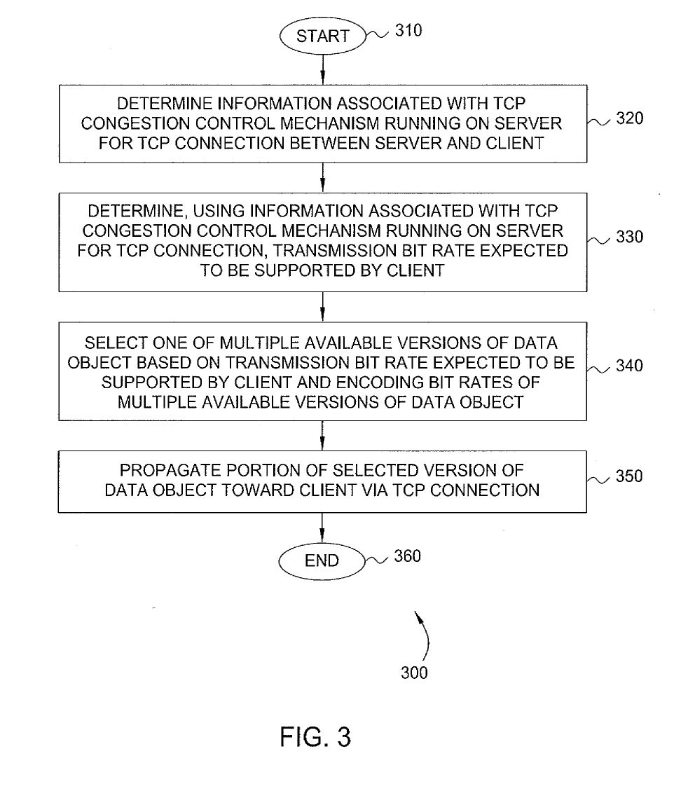

The operation of server-side adaptive streaming mechanism 111 of server 110 in providing various functions of the server-side adaptive streaming capability may be better understood by way of reference to FIG. 3.

FIG. 3 depicts one embodiment of a method by which a server selects, from among multiple versions of a data object available to the server, one of the versions of the data object from which to propagate a portion of the data object toward a client via a TCP connection. The steps of method 300 of FIG. 3 may be better understood when read in conjunction with the description of FIG. 1. Although the steps of method 300 of FIG. 3 are depicted and described as being performed serially, the steps of method 300 may be performed contemporaneously and/or in a different order than presented.

At step 310, method 300 begins.

At step 320, information associated with a TCP congestion control mechanism, running on the server for the TCP connection, is determined.

At step 330, a transmission bit rate expected to be supported by the client is determined using the information associated with a TCP congestion control mechanism running on the server.

At step 340, a version of the data object is selected based on the transmission bit rate expected to be supported by the client and encoding bit rates of the multiple versions of the data object available for selection.

At step 350, a portion of the data object from the selected version of the data object is propagated from the server toward the client via the TCP connection.

At step 360, method 300 ends.

Although depicted and described as ending (for purposes of clarity), it is noted that the method 300 may continue to be repeated by the server for streaming the data object toward the client. The method 300 and/or portions of method 300 may be repeated in any suitable manner and upon any suitable basis.

In one embodiment, for example, method 300 or portions of method 300 may be repeated periodically based on data object portions. For example, method 300 may be repeated once for each portion of the data object to be propagated from the server toward the client. For example, steps 320 and 330 of method 300 may be repeated once for every five contiguous portions of the data object to be propagated from the server toward the client and then the next four portions of the data object are selected from the same version of the data object based on that execution of steps 320 and 330.

In one embodiment, for example, method 300 or portions of method 300 may be repeated periodically based on time (e.g., once every 100 ms, once each second, and the like).

For example, method 300 may be repeated once every ten seconds where each portion of the data object to be propagated from the server toward the client is ten seconds in length. For example, steps 320 and 330 of method 300 may be repeated once every twenty seconds where each portion of the data object to be propagated from the server toward the client is two seconds in length (such that, after selection of a version of the data object for the first two-second portion of the data object, the next nine two-second portions of the data object are selected from the same version of the data object based on that execution of steps 320 and 330).

In one embodiment, for example, method 300 or portions of method 300 may be performed in response to one or more trigger conditions. For example, steps 320 and 330 may be performed by the server continuously monitoring the TCP congestion control process for the TCP connection (as portions of the data object continue to be streamed toward the client from the previously selected version of the data object) until one or more parameters of the TCP congestion control process indicates that the version of the data object currently being propagated toward the client is no longer the optimal or desired version of the data object to be propagated toward the client, thereby triggering selection of a new version of the data object and propagation of portions of the newly selected version of the data object toward the client. For example, portions of the data object may be streamed toward the client from the previously selected version of the data object (e.g., selected during the previous execution of method 300) until an event detected at the server indicates that the method 300 should be executed again (which may result in selection of the same or a different version of the data object from which portions of the data object are then streamed to the client).

It is noted that various combinations of such embodiments may be used for controlling the manner in which the server determines whether to switch between different versions of the data object and, ultimately, switches between different versions of the data object. In this manner, as noted herein, the TCP stream output by the server for delivery to the client is a single contiguous data-stream even though the server may have assembled it from multiple different versions of the data object encoded at different encoding bit rates.

In at least some embodiments, the server-side adaptive streaming capability obviates the need for a client to include any special client software in order for the client to benefit from adaptive streaming. For example, clients that support client-side adaptive streaming and clients that do not support client-side adaptive streaming each may benefit from the server-side adaptive streaming capability depicted and described herein. As a result, the server-side adaptive streaming capability supports adaptive streaming to any client device via any type of TCP connection.

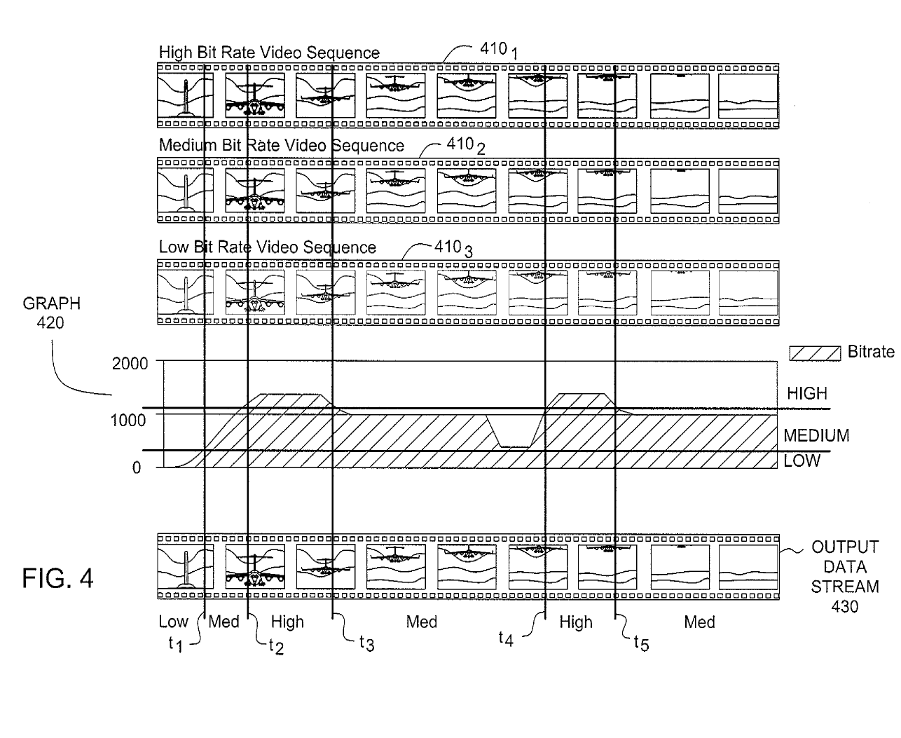

FIG. 4 depicts use of a server-side adaptive streaming mechanism on a server to produce an output data stream for a client from three encoded versions of the data object accessible to the server.

As depicted in FIG. 4, three video sequences 410₁-410₃ (collectively, video sequences 410) are used, based on the transmission bit rate expected to be supported by the client for the TCP connection as represented by a graph 420, to assemble an output data stream 430.

The three encoded versions of the data object include a high bit rate video sequence 410₁, a medium bit rate video sequence 410₂, and a low bit rate video sequence 410₃ (collectively, video sequences 410). The video sequences 410 each include the same video content (i.e., they are different encoded versions, encoded at different rates, of the same video content object). In FIG. 4, video sequences 410 are aligned temporally with respect to each other for purposes of clarity in illustrating the different quality levels of the video sequences 410.

The graph 420, as indicated above, represents the value of the transmission bit rate expected to be supported by the client for the TCP connection as determined by the server over time. As depicted in graph 420, the value of the transmission bit rate expected to be supported by the client for the TCP connection changes over time (e.g., in response to various changing conditions). As further depicted in graph 420, there are two threshold levels for the value of the transmission bit rate expected to be supported by the client for the TCP connection, which define three ranges of transmission bit rates expected to be supported by the client for the TCP connection as follows: (1) a LOW range which indicates that, for a value of the transmission bit rate expected to be supported by the client for the TCP connection that is within this range, the low bit rate video sequence 410₃ is to be selected by the server for use in the output data stream 430, (2) a MEDIUM range which indicates that, for a value of the transmission bit rate expected to be supported by the client for the TCP connection that is within this range, the medium bit rate video sequence 410₂ is to be selected by the server for use in the output data stream 430, and (3) a HIGH range which indicates that, for a value of the transmission bit rate expected to be supported by the client for the TCP connection that is within this range, the high bit rate video sequence 410₁ is to be selected by the server for use in the output data stream 430. In FIG. 4, the graph 420 is aligned temporally with respect to each of the video sequences 410 and the output data stream 430. It is noted that the values of the transmission bit rates marked on the graph 420 are merely exemplary and, similarly, that the definition of the LOW, MEDIUM, and HIGH ranges on the graph 420 also are merely exemplary (e.g., any suitable expected transmission bit rate values may be determined by the server, the ranges of expected transmission bit rate values used for determining selection between available video sequences may be defined in any suitable manner, any suitable number of ranges of expected transmission bit rate values used to determine selection between available video sequences may be employed, and the like, as well as various combinations thereof).

The output data stream 430 is assembled using various portions of the video sequences 410. The server-side adaptive streaming mechanism of the server assembles the output data stream 430 by evaluating information, associated with a TCP congestion control mechanism running on the server for the TCP connection, for appropriately selecting video content from video sequences 410 for use as the output data stream 430. The selection of video content from the video sequences 410, based on the values of transmission bit rate expected to be supported by the client for the TCP connection as represented by graph 420, for use as the output data stream 430 is depicted in FIG. 4.

As depicted in FIG. 4, server-side adaptive streaming mechanism controls selection of video content from video sequences 410 for use as the output data stream 430 as follows: (a) before time t₁, the transmission bit rate expected to be supported by the client for the TCP connection is in the LOW range and, thus, the output data stream 430 includes video from low bit rate video sequence 410₃, (b) at time t₁, the transmission bit rate expected to be supported by the client for the TCP connection crosses the threshold between the LOW and MEDIUM ranges and, thus, the server switches from using video from the low bit rate video sequence 410₃ to using video from the medium bit rate video sequence 410₂, (c) between times t₁ and t₂, the output data stream 430 includes video from medium bit rate video sequence 410₂, (d) at time t₂, the transmission bit rate expected to be supported by the client for the TCP connection crosses the threshold between the MEDIUM and HIGH ranges and, thus, the server switches from using video from the medium bit rate video sequence 410₂ to using video from the high bit rate video sequence 410₁, (e) between times t₂ and t₃, the output data stream 430 includes video from high bit rate video sequence 410₁, (f) at time t₃, the transmission bit rate expected to be supported by the client for the TCP connection crosses the threshold between the HIGH and MEDIUM ranges and, thus, the server switches from using video from the high bit rate video sequence 410₁ to using video from the medium bit rate video sequence 410₂, (g) between times t₃ and t₄, the output data stream 430 includes video from medium bit rate video sequence 410₂, (h) at time t₄, the transmission bit rate expected to be supported by the client for the TCP connection crosses the threshold between the MEDIUM and HIGH ranges and, thus, the server switches from using video from the medium bit rate video sequence 410₂ to using video from the high bit rate video sequence 410₁, (i) between times t₄ and t₅, the output data stream 430 includes video from high bit rate video sequence 410₁, (j) at time t₅, the transmission bit rate expected to be supported by the client for the TCP connection crosses the threshold between the HIGH and MEDIUM ranges and, thus, the server switches from using video from the high bit rate video sequence 410₁ to using video from the medium bit rate video sequence 410₂, and (k) after time t₅, the output data stream 430 includes video from medium bit rate video sequence 410₂.

In this manner, server-side adaptive streaming mechanism produces an output data stream 430 for the TCP connection to the client, based on information associated with a TCP congestion control mechanism running on the server for the TCP connection, that is optimized for the transmission bit rate expected to be supported by the client for the TCP connection.

Although primarily depicted and described herein with respect to embodiments in which the server-side adaptive streaming capability is provided for a TCP connection between a server and a client, it is noted that embodiments of the server-side adaptive streaming capability may be used to provide adaptive streaming for TCP connections between other types of devices. As such, the terms “server” and “client” may be referred to more generally, e.g., data source and data destination, as source computer and destination computer, or using any other suitable terms. Furthermore, references to such devices also may be considered to be references to the programs, running on the devices, for which the TCP connection is used (e.g., application programs or any other suitable type(s) of programs which may utilize a TCP connection for transfer of data).

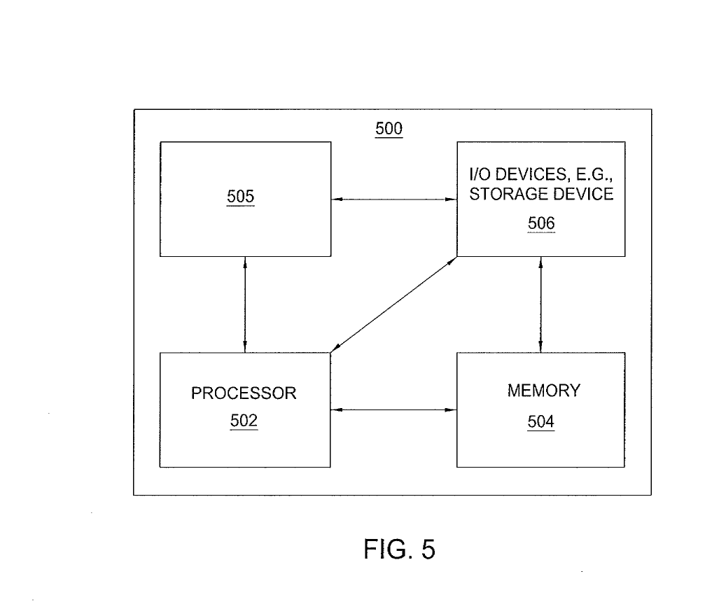

FIG. 5 depicts a high-level block diagram of a computer suitable for use in performing functions described herein.

As depicted in FIG. 5, computer 500 includes a processor element 502 (e.g., a central processing unit (CPU) and/or other suitable processor(s)) and a memory 504 (e.g., random access memory (RAM), read only memory (ROM), and the like). The computer 500 also may include a cooperating module/process 505 and/or various input/output devices 506 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software (e.g., via implementation of software on one or more processors) and/or hardware (e.g., using a general purpose computer, one or more application specific integrated circuits (ASIC), and/or any other hardware equivalents).

It will be appreciated that the functions depicted and described herein may be implemented in software for executing on a general purpose computer (e.g., via execution by one or more processors) so as to implement a special purpose computer, and/or may be implemented in hardware (e.g., using one or more application specific integrated circuits (ASIC) and/or one or more other hardware equivalents).

In one embodiment, the cooperating process 505 can be loaded into memory 504 and executed by processor 502 to implement functions as discussed herein. Thus, cooperating process 505 (including associated data structures) can be stored on a computer readable storage medium, e.g., RAM memory, magnetic or optical drive or diskette, and the like.

It will be appreciated that computer 500 depicted in FIG. 5 provides a general architecture and functionality suitable for implementing functional elements described herein and/or portions of functional elements described herein. For example, the computer 500 provides a general architecture and functionality suitable for implementing one or more of the server 110, a portion of the server 110, the server-side adaptive streaming mechanism 111, a portion of the server-side adaptive streaming mechanism 111, the client 120, a portion of the client 120, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus for adaptive streaming of a data object from a server toward a client via a Transmission Control Protocol (TCP) connection, the server having access to a plurality of versions of the data object having a respective plurality of encoding bit rates associated therewith, the apparatus comprising:
a processor and a memory, the processor configured to:
determine, from information associated with a TCP congestion control mechanism running on the server for the TCP connection, a transmission bit rate expected to be supported by the client for the TCP connection; and
select, based on the transmission bit rate expected to be supported by the client and the encoding bit rates associated with the versions of the data object accessible to the server, one of the plurality of versions of the data object for propagation from the server toward the client via the TCP connection.

2. The apparatus of claim 1, wherein the selected one of the versions of the data object is a first version of the data object, wherein the processor is configured to:
when the transmission bit rate expected to be supported by the client changes to a new transmission bit rate expected to be supported by the client, switch from selecting the first version of the data object to selecting a second version of the data object from the plurality of versions of the data object, wherein the encoding bit rate of the second version of the data object is compatible with the new transmission bit rate expected to be supported by the client.

3. The apparatus of claim 1, wherein the processor is configured to determine the information associated with a TCP congestion control mechanism running on the server for the TCP connection from a TCP stack on the server.

4. The apparatus of claim 1, wherein the information associated with the TCP congestion control mechanism running on the server for the TCP connection comprises a current transmission bit rate of the TCP connection on the server.

5. The apparatus of claim 4, wherein the transmission bit rate expected to be supported by the client for the TCP connection is determined as the current transmission bit rate of the TCP connection on the server.

6. The apparatus of claim 4, wherein the information associated with the TCP congestion control mechanism running on the server for the TCP connection comprises at least one additional parameter associated with the TCP connection.

7. The apparatus of claim 6, wherein the at least one additional parameter associated with the TCP connection comprises at least one of a peak transmission bit rate at which the data object is transmitted from the server toward the client via the TCP connection, a measure of packet loss for the TCP connection, an indication of intermittent packet loss for the TCP connection, and a round-trip time associated with the TCP connection.

8. The apparatus of claim 6, wherein the processor is configured to:
select one of the plurality of versions of the data object, based on the transmission bit rate expected to be supported by the client and the at least one additional parameter associated with the TCP connection.

9. The apparatus of claim 1, wherein the processor is configured to:
propagate the selected version of the data object toward the client.

10. The apparatus of claim 1, wherein the data object comprises video content.

11. A method for adaptive streaming of a data object from a server toward a client via a Transmission Control Protocol (TCP) connection, the server having access to a plurality of versions of the data object having a respective plurality of encoding bit rates associated therewith, the method comprising:
using a processor and a memory for:
determining, from information associated with a TCP congestion control mechanism running on the server for the TCP connection, a transmission bit rate expected to be supported by the client for the TCP connection; and
selecting, based on the transmission bit rate expected to be supported by the client and the encoding bit rates associated with the versions of the data object accessible to the server, one of the plurality of versions of the data object for propagation from the server toward the client via the TCP connection.

12. The method of claim 11, wherein the selected one of the versions of the data object is a first version of the data object, the method further comprising:
when the transmission bit rate expected to be supported by the client changes to a new transmission bit rate expected to be supported by the client, switching from selecting the first version of the data object to selecting a second version of the data object from the plurality of versions of the data object, wherein the encoding bit rate of the second version of the data object is compatible with the new transmission bit rate expected to be supported by the client.

13. The method of claim 11, wherein the information associated with a TCP congestion control mechanism running on the server for the TCP connection is determined from a TCP stack on the server.

14. The method of claim 11, wherein the information associated with the TCP congestion control mechanism running on the server for the TCP connection comprises a current transmission bit rate of the TCP connection on the server.

15. The method of claim 14, wherein the transmission bit rate expected to be supported by the client for the TCP connection is determined as the current transmission bit rate of the TCP connection on the server.

16. The method of claim 14, wherein the information associated with the TCP congestion control mechanism running on the server for the TCP connection comprises at least one additional parameter associated with the TCP connection.

17. The method of claim 16, wherein the at least one additional parameter associated with the TCP connection comprises at least one of a peak transmission bit rate at which the data object is transmitted from the server toward the client via the TCP connection, a measure of packet loss for the TCP connection, an indication of intermittent packet loss for the TCP connection, and a round-trip time associated with the TCP connection.

18. The method of claim 16, further comprising:
selecting one of the plurality of versions of the data object, based on the transmission bit rate expected to be supported by the client and the at least one additional parameter associated with the TCP connection.

19. The method of claim 11, further comprising:
propagating the selected version of the data object toward the client.

20. The method of claim 11, wherein the data object comprises video content.

21. A computer-readable storage medium storing instructions which, when executed by a computer, cause the computer to perform a method for adaptive streaming of a data object from a server toward a client via a Transmission Control Protocol (TCP) connection, the server having access to a plurality of versions of the data object having a respective plurality of encoding bit rates associated therewith, the method comprising:
determining, from information associated with a TCP congestion control mechanism running on the server for the TCP connection, a transmission bit rate expected to be supported by the client for the TCP connection; and
selecting, based on the transmission bit rate expected to be supported by the client and the encoding bit rates associated with the versions of the data object accessible to the server, one of the plurality of versions of the data object for propagation from the server toward the client via the TCP connection.

22. An apparatus for adaptive streaming of a data object from a server toward a client via a Transmission Control Protocol (TCP) connection, the server having access to a plurality of versions of the data object having a respective plurality of encoding bit rates associated therewith, the apparatus comprising:
a processor and a memory, the processor configured to:
determine, from information associated with a TCP congestion control mechanism running on the server for the TCP connection, a transmission bit rate expected to be supported by the client for the TCP connection; and
switch, based on the transmission bit rate expected to be supported by the client and the encoding bit rates associated with the versions of the data object accessible to the server, from selecting a first one of the plurality of versions of the data object for propagation from the server toward the client via the TCP connection to selecting a second one of the plurality of versions of the data object for propagation from the server toward the client via the TCP connection.
